(19) United States
(12) Patent Application Publication
(10) Pub. No.: US 2022/0166666 A1
(43) Pub. Date: May 26, 2022

(54) DATA PLANE OPERATION IN A PACKET PROCESSING DEVICE

(71) Applicant: Intel Corporation, Santa Clara, CA (US)

(72) Inventors: Anjali Singhai JAIN, Portland, OR (US); Keren GUY, Sunnyvale, CA (US); Jayaprakash SHANMUGAM, Portland, OR (US); Neerav PARIKH, Hillsboro, OR (US); Daniel DALY, Santa Barbara, CA (US); Arunkumar BALAKRISHNAN, Santa Clara, CA (US)

(21) Appl. No.: 17/670,355

(22) Filed: Feb. 11, 2022

(51) Int. Cl. H04L 41/0803

(52) U.S. Cl. CPC H04L 41/0803

(57) ABSTRACT

Examples described herein relate to a packet processing device that includes circuitry to perform packet processing operations according to a configuration and circuitry to execute control plane software to provide the configuration to the circuitry to perform packet processing operations according to the configuration. In some examples, the circuitry to perform packet processing operations according to the configuration is to continue operation independent of operation of the circuitry to execute control plane software.

### BACKGROUND

In a datacenter, some network interface devices include programmable data planes that are configurable by a control plane. The control plane can configure the programmable data planes with certain rules of operation so that the network interface device can independently perform packet processing operations.

### BRIEF DESCRIPTION OF THE DRAWINGS

FIG. 1 depicts an example system.

FIG. 2 depicts an example of operations.

FIG. 3 depicts an example of operations.

FIG. 4 depicts an example process.

FIG. 5 depicts an example packet processing device.

FIG. 6 depicts an example packet processing pipeline.

FIG. 7 depicts an example computing system.

FIG. 8 depicts an example computing system.

### DETAILED DESCRIPTION

In at least a packet processing device that includes multiple processors and a programmable data plane, and one or more of the multiple processors executes a control plane, some examples provide independent operation of the control plane and the programmable data plane so that the control plane software can be rebooted, restarted or updated and a configured data plane can continue to process packets. Some examples provide that after configuration of the data plane by the control plane, packets in a traffic flow can be processed by the data plane independent of software or operating status of the control plane or processor that executes the control plane. Some examples provide ability to update operating system software of a control plane, while the data plane continues to process packets to be sent to the network or received from the network. Some examples store and allocate in memory one or more of the following for access by the data plane: data plane configurations, data queues, interrupts, allocation, or receive side scaling table and rules.

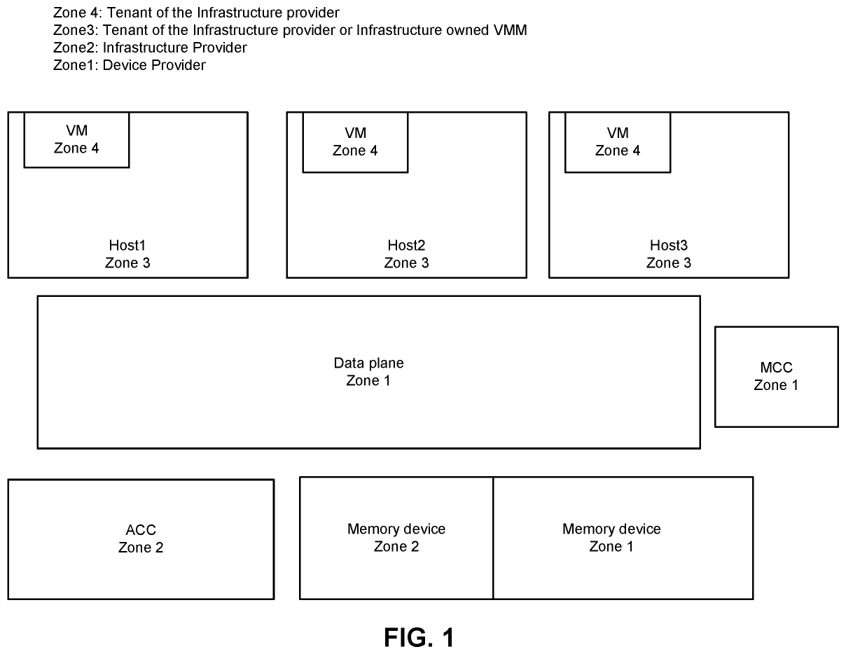

FIG. 1 depicts an example of security zones. For example, zone 1 can be programmed by a device provider. In this example, zone 1 can be associated with a data plane circuitry, Management Compute Complex (MCC), and addressable portions of memory allocated to store an operating system for an MCC, and backing store. In some examples, MCC can control host interfaces with the data plane circuitry of a packet processing device in order to communicate with a host.

Zone 2 can be programmed by an infrastructure provider. For example, zone 2 can be associated with addressable portions of memory allocated to store an operating system of an Acceleration Compute Complex (ACC) or other microprocessor and the ACC. In some examples, the ACC can control packet traffic flow to or from a virtual machine (VM) (or microservice, container, application, or combination thereof) as well as other devices connected in a network. During a software update to devices in zone 2, devices in zone 1 are not reset and can continue operation.

Zone 3 can represent a bare metal case and can be programmed by a tenant or a virtual machine manager (VMM). For example, zone 3 can be associated with host1, host2, and host3.

Zone 4 can be programmed by a tenant. For example, zone 4 can be associated with VMs executed by host1, host2, and host3.

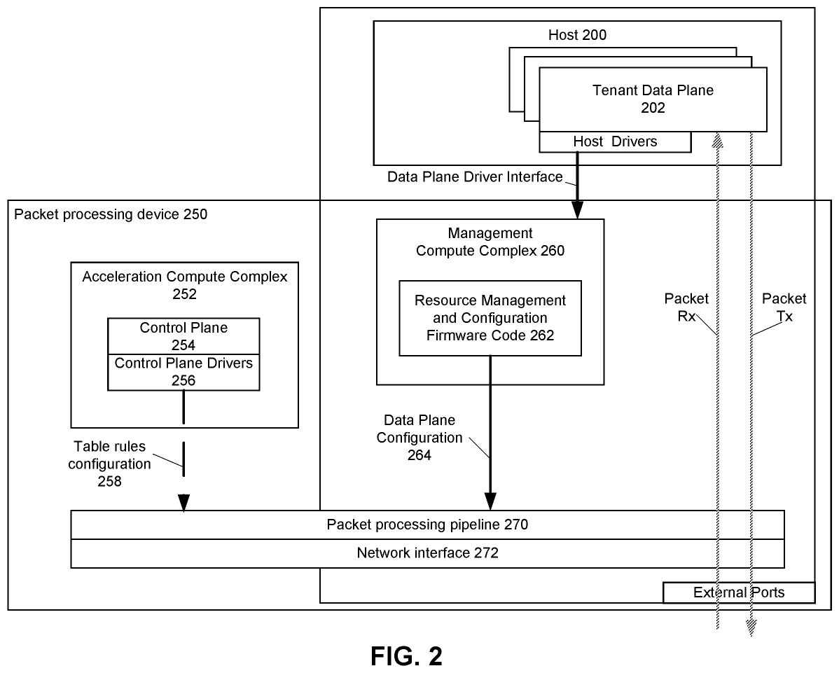

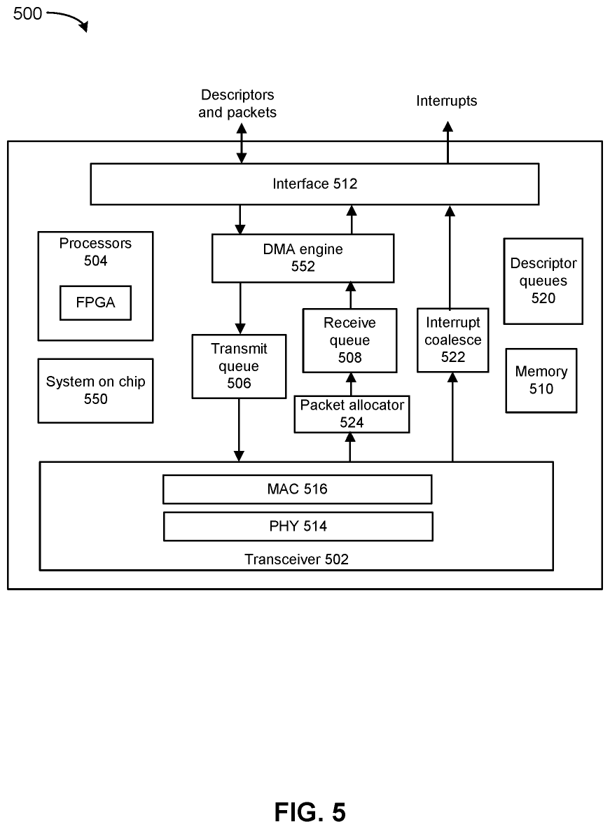

FIG. 2 depicts an example system. Packet processing device 250 can include multiple compute complexes, such as an Acceleration Compute Complex (ACC) 252 and Management Compute Complex (MCC) 260. Packet processing device 250 can include other circuitry described at least with respect to FIGS. 5-8.

ACC 252 can be implemented as one or more of: a microprocessor, processor, accelerator, field programmable gate array (FPGA), application specific integrated circuit (ASIC) or other circuitry described at least with respect to FIGS. 5-8. Similarly, MCC 260 can be implemented as one or more of: a microprocessor, processor, accelerator, field programmable gate array (FPGA), application specific integrated circuit (ASIC) or other circuitry described at least with respect to FIGS. 5-8.

In some examples, ACC 252 and MCC 260 can be implemented as separate cores in a CPU, different cores in different CPUs, different processors in a same integrated circuit, different processors in different integrated circuit.

In some examples, ACC 252 can execute a control plane and MCC 260 can execute a control plane. One or both control planes of ACC 252 and MCC 260 can define traffic routing table content and network topology applied by packet processing pipeline 270 to select a path of a packet in a network to a next hop or to a destination network-connected device.

A software defined networking (SDN) controller (not shown) can upgrade or reconfigure software executing on ACC 252 through contents of packets received through network interface 272. The SDN controller can provide rules for application by ACC 252. The SDN controller can pause updating flow policies when ACC 252 is upgraded or reset. ACC 252 can program table rules (e.g., header field match and corresponding action) into memory accessible to packet processing pipeline 270 based on change in policy and changes in VMs, containers, microservices, applications, or other processes.

In some examples, ACC 252 can execute control plane operating system (OS) (e.g., Linux) and/or a control plane application (e.g., user space or kernel modules used by a remote SDN controller to control packet processing pipeline 270. A control plane application can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents).

For example, ACC 252 can execute a virtual switch such as vSwitch or Open vSwitch (OVS), Stratum, or VPP that provides communications between virtual machines executed by host 200 or with other devices connected to a network. ACC 252 can be configured to provide network policy as flow cache rules into a table accessible to packet processing pipeline 270 for application by packet processing pipeline 270. For example, the ACC-executed control plane application can configure rule tables applied by packet processing pipeline 270 with rules to define a traffic destination based on packet type and content. For example, ACC 252 can configure packet processing pipeline 270 as to which VM is to receive traffic and what kind of traffic a VM can transmit. ACC 252 can program table rules (e.g., match action) into memory accessible to packet processing pipeline 270 based on change in policy and changes in VMs.

For example, a VM can include tenant data plane 202 and host driver. Host driver can include physical function (PF) and/or virtual function (VF) drivers and kernel. Drivers can communicate with MCC 260. Tenant data plane 202 can send a request to MCC 260 through a host driver and data plane driver interface to allocate hardware resources of packet processing pipeline 270 for its use. MCC 260 can execute a control plane software including resource management and configuration firmware code 262 to allocate the resources according to the tenant request. MCC 260 can store a record of hardware resources allocated for a tenant.

MCC 260 can be configured as a secure entity in packet processing device 250 that is configurable by a host driver and/or tenant data plane 202. MCC 260 can execute a host management control plane and global resource manager. MCC 260 can execute a virtual switch control plane and configure a virtual switch executed in packet processing pipeline 270. For example, packet processing pipeline 270 can execute a virtual switch such as vSwitch or OVS that provides communications between virtual machines executed by host 200 and packet processing device 250.

MCC 260 can configure data plane configurations and resources of packet processing pipeline 270. For example, a VM executing on host 200 can utilize packet processing device 250 to receive or transmit traffic. Reference to VM, application, container, microservice, thread, or function can refer to another one or more of: a process, VM, application, container, microservice, thread, or function.

MCC 260 can allocate one or more addressable memory regions for use by ACC 252 that store match-action entries. MCC 260 can configure packet processing pipeline 270 with connectivity (e.g., queues or DMA) to provide data connectivity between host 200 and packet processing pipeline 270.

Some examples provide data plane isolation from the control plane. For example, ACC 252, MCC 260, and memory can be isolated so that packet processing pipeline 270 (after programming by ACC 252) can operate on rules in memory during ACC 252 upgrade or downtime. When ACC 252 is reset or is subject to a software update (e.g., change of control plane operating system and/or control plane application), the tenant traffic processed by packet processing pipeline 270 may not be impacted as the data path configuration and queries can continue to be applied by packet processing pipeline 270 based on a prior configuration from ACC 252 or a configuration from MCC 260. In other words, after packet processing pipeline 270 is configured, data plane resources and configurations are not affected by a state of ACC 252. Therefore, the tenant workloads performed by packet processing pipeline 270 may not be affected by disconnection of ACC 252 from packet processing pipeline 270. MCC 260 can continue to manage resources of packet processing pipeline 270, so that traffic through packet processing pipeline 270 is independent from software state or operating state of ACC 252. Examples provide an ability to update or restart ACC control plane software 254 without affecting the tenant application that utilize packet processing pipeline 270.

Packet processing pipeline 270 can be implemented using one or more of: application specific integrated circuit (ASIC), field programmable gate array (FPGA), processors executing software, or other circuitry. Various examples of packet processing pipeline 270 are described herein.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

An example flow of operation is as follows. At (1), host tenant requests for network connectivity through data plane driver interface by providing interface characteristics. At (2), MCC 260 processes and performs the request. For example, MCC 260 can allocate resources based on pre-defined policy and configure resources to provide such connectivity. The resources can include one or more of: data queues, interrupt settings, receive side scaling table allocation, access to DMA circuitry, or others. At (3), the tenant is to communicate with another network interface device and able to process received packets that are processed by the packet processing pipeline and cause transmission of packets that are processed by the packet processing pipeline. At (4), ACC control plane 254 can configure table rules with match-action entries applied by packet processing pipeline 270. For example, table rules can include classifications such as exact match or wild card match classifications and associated actions. ACC control plane 254 can allocate and configure packet processing pipeline 270 to generate per flow statistics as well.

At (5), ACC control plane 254 begins a software upgrade process, operating system update, and ACC direct memory access (DMA) link to host 200 is broken, or is reset for any other reason. As data plane resources are allocated, managed, and configured by MCC 260 instead of ACC 252, data traffic is processed by packet processing pipeline 270. MCC 260 manages host interface connection between host 200 and packet processing pipeline 270. Host 200 can configure MCC 260 to perform offloaded operations (e.g., checksum, receive side coalescing (RSC), load balancing, and so forth).

Accordingly, tenant's network connectivity and traffic can continue and additional tenant requests can be handled by the MCC. After ACC 252 is available (e.g., after a software update or restart), the ACC control plane 254 can adjust a configuration of packet processing pipeline 270 based on commands from an SDN controller. After ACC 252 update is completed, the SDN controller can continue to send changes to packet processing pipeline 270 via ACC 252. After ACC 252 is operational, ACC control plane 254 can learn about the state of packet processing pipeline 270 from queries, queries by MCC 260, persistent storage and/or OS that runs on ACC 252 (e.g., SONIC), which can take a snapshot and capture state in a file.

In some examples, operation of ACC 252, MCC 260, and/or packet processing pipeline 270 can be configured using software based on one or more of Data Plane Development Kit (DPDK) or Open Data Plane (ODP).

In some examples, if maintenance is performed in packet processing device 250 and not host 200, live migration of VMs from host 200 to another host can be avoided and updates to packet processing device 250 can occur while VMs executed by host 200 continue with packet transmit and receipt.

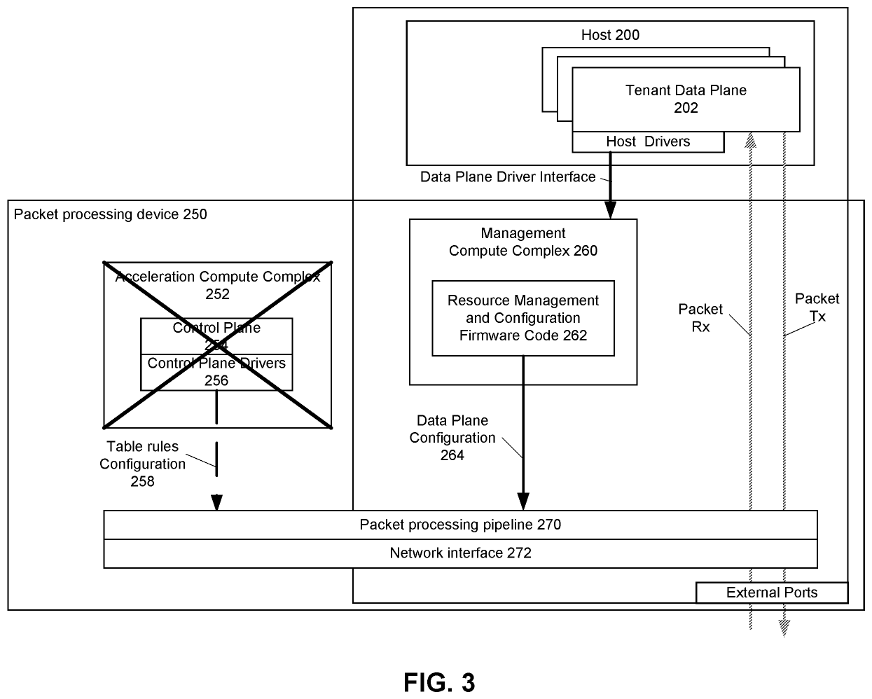

FIG. 3 depicts an example operation during an upgrade, reset, reboot, or other unavailability of an ACC. When ACC 252 goes offline (e.g., through an upgrade or reset), and ACC 252 may not be available to add new flow rules to packet processing pipeline 270. Although ACC 252 is not functional, data can be transmitted (TX) and received (RX) using packet processing pipeline 270 based on configurations previously loaded into packet processing pipeline 270. For example, packet processing pipeline 270 can operate using rules (e.g., open port X, IP addresses allowed) that were programmed by ACC 252 before ACC 252 went offline. MCC 260 can configure using packet processing pipeline 270 so that packet transmission and receipt can continue to occur while ACC 252 is offline. MCC 260 can control an interface between packet processing pipeline 270 and host 200 to permit copying of packets from packet processing device 250 to host 200 or packets from host 200 to packet processing device 250.

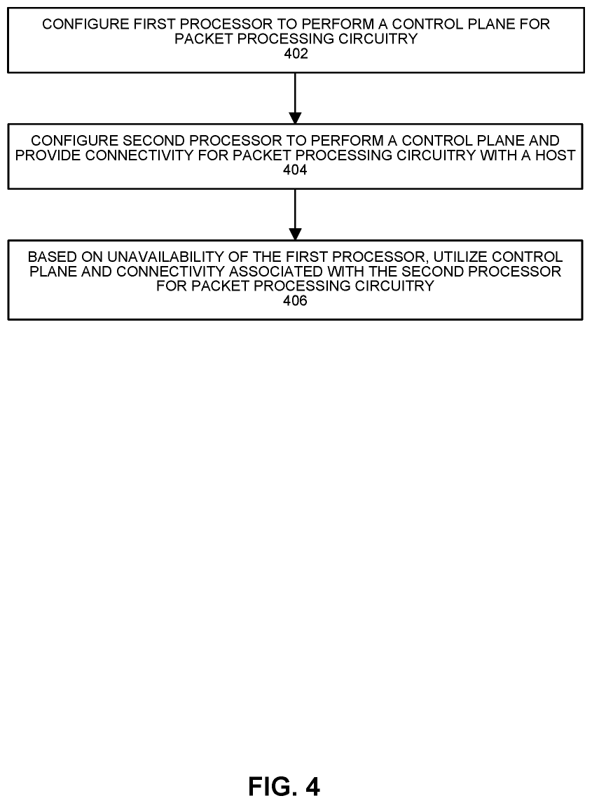

FIG. 4 depicts an example process. The process can be performed by a packet processing device that includes at least a first processor, a second processor, and a programmable packet processing circuitry. At 402, the first processor can be configured to execute a control plane to program the programmable packet processing circuitry. For example, various match-action entries can be programmed and stored in a region of memory that is accessible to the programmable packet processing circuitry independent from operation or non-operation of the first processor. A host or SDN controller can configure the operation of the control plane executed by the first processor.

At 404, the second processor can be configured to execute a control plane to program communications between the programmable packet processing circuitry and a host system as well as the programmable packet processing circuitry. For example, communications can include connectivity resources such as one or more of: data queues, interrupt settings, receive side scaling table allocation, access to DMA circuitry, or others. A host or SDN controller can configure the operation of the control plane executed by the second processor.

At 406, based on unavailability of first processor, the programmable packet processing circuitry can utilize prior configurations from the first processor. In addition, the programmable packet processing circuitry can communicate with the host using connectivity resources allocated by the second processor, which operates during unavailability of the first processor. In some examples, the second processor can issue new match-action configurations to the programmable packet processing circuitry or update match-action configurations applied by the match-action configurations. After the first processor is available (e.g., after a software update or restart), the first processor can adjust a configuration of the programmable packet processing circuitry.

FIG. 5 depicts an example packet processing device. In some examples, configuration of programmable pipelines of the packet processing device can be programmed using a processor of processors 504 and operation of the programmable pipelines can continue during updates to software executing on the processor, or other unavailability of the processor, as a second processor of processors 504 provides connectivity to a host such as one or more servers and the second processor can configure operation of programmable pipelines, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or DDR. Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

Processors 504 can be any a combination of a: processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed using Programming Protocol-independent Packet Processors (P4), C, Python, Broadcom Network Programming Language (NPL), or x86 compatible executable binaries or other executable binaries. Processors 504 and/or system on chip 550 can execute instructions to configure and utilize one or more circuitry as well as check against violation against use configurations, as described herein.

Packet allocator 524 can provide distribution of received packets for processing by multiple CPUs or cores using timeslot allocation described herein or RSS. When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with PCI, PCI Express, PCI-x, Serial ATA, and/or USB compatible interface (although other interconnection standards may be used).

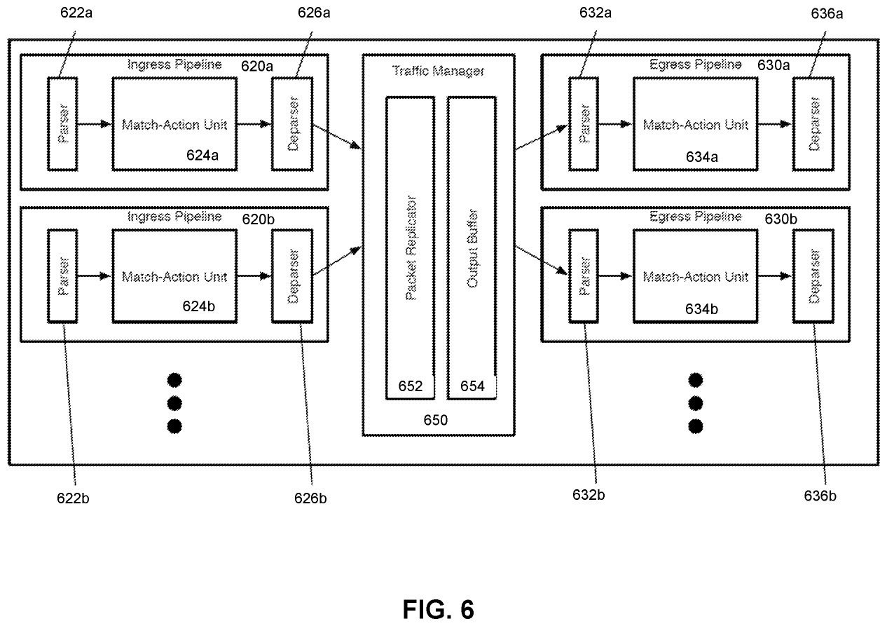

FIG. 6 depicts an example packet processing pipeline that can be used in a switch, network device, or packet processing device. A packet processing pipeline several ingress pipelines 620, a traffic management unit (referred to as a traffic manager) 650, and several egress pipelines 630. Though shown as separate structures, in some examples the ingress pipelines 620 and the egress pipelines 630 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

Configuration of the packet processing pipeline can take place in accordance with embodiments described herein. Configuration of operation of packet processing pipelines, including its data plane, can be programmed using P4, C, Python, Broadcom Network Programming Language (NPL), or x86 compatible executable binaries or other executable binaries.

In some examples, in response to receiving a packet, the packet is directed to one of the ingress pipelines 620 where an ingress pipeline which may correspond to one or more ports of a hardware forwarding element. After passing through the selected ingress pipeline 620, the packet is sent to the traffic manager 650, where the packet is enqueued and placed in the output buffer 654. In some examples, the ingress pipeline 620 that processes the packet specifies into which queue the packet is to be placed by the traffic manager 650 (e.g., based on the destination of the packet or a flow identifier of the packet). The traffic manager 650 then dispatches the packet to the appropriate egress pipeline 630 where an egress pipeline may correspond to one or more ports of the forwarding element. In some examples, there is no necessary correlation between which of the ingress pipelines 620 processes a packet and to which of the egress pipelines 630 the traffic manager 650 dispatches the packet. That is, a packet might be initially processed by ingress pipeline 620b after receipt through a first port, and then subsequently by egress pipeline 630a to be sent out a second port, etc.

A least one ingress pipeline 620 includes a parser 622, plural match-action units (MAUs) 624, and a deparser 626. Similarly, egress pipeline 630 can include a parser 632, plural MAUs 634, and a deparser 636. The parser 622 or 632, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 622 or 632 separates out the packet headers (up to a designated point) from the payload of the packet, and sends the payload (or the entire packet, including the headers and payload) directly to the deparser without passing through the MAU processing.

MAUs 624 or 634 can perform processing on the packet data. In some examples, MAUs includes a sequence of stages, with a stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can be used to determine whether to migrate data to another memory device and select another memory device, as described herein.

The deparser 626 or 636 can reconstruct the packet using a packet header vector (PHV) as modified by the MAU 624 or 634 and the payload received directly from the parser 622 or 632. The deparser can construct a packet that can be sent out over the physical network, or to the traffic manager 650. In some examples, the deparser can construct this packet based on data received along with the PHV that specifies the protocols to include in the packet header, as well as its own stored list of data container locations for possible protocol's header fields.

Traffic manager 650 can include a packet replicator 652 and output buffer 654. In some examples, the traffic manager 650 may include other components, such as a feedback generator for sending signals regarding output port failures, a series of queues and schedulers for these queues, queue state analysis components, as well as additional components. The packet replicator 652 of some examples performs replication for broadcast/multicast packets, generating multiple packets to be added to the output buffer (e.g., to be distributed to different egress pipelines).

The output buffer 654 can be part of a queuing and buffering system of the traffic manager in some examples. The traffic manager 650 can provide a shared buffer that accommodates any queuing delays in the egress pipelines. In some examples, this shared output buffer 654 can store packet data, while references (e.g., pointers) to that packet data are kept in different queues for egress pipeline 630. The egress pipelines can request their respective data from the common data buffer using a queuing policy that is control-plane configurable. When a packet data reference reaches the head of its queue and is scheduled for dequeuing, the corresponding packet data can be read out of the output buffer 654 and into the corresponding egress pipeline 630. In some examples, packet data may be referenced by multiple pipelines (e.g., for a multicast packet). In this case, the packet data is not removed from this output buffer 654 until references to the packet data have cleared their respective queues.

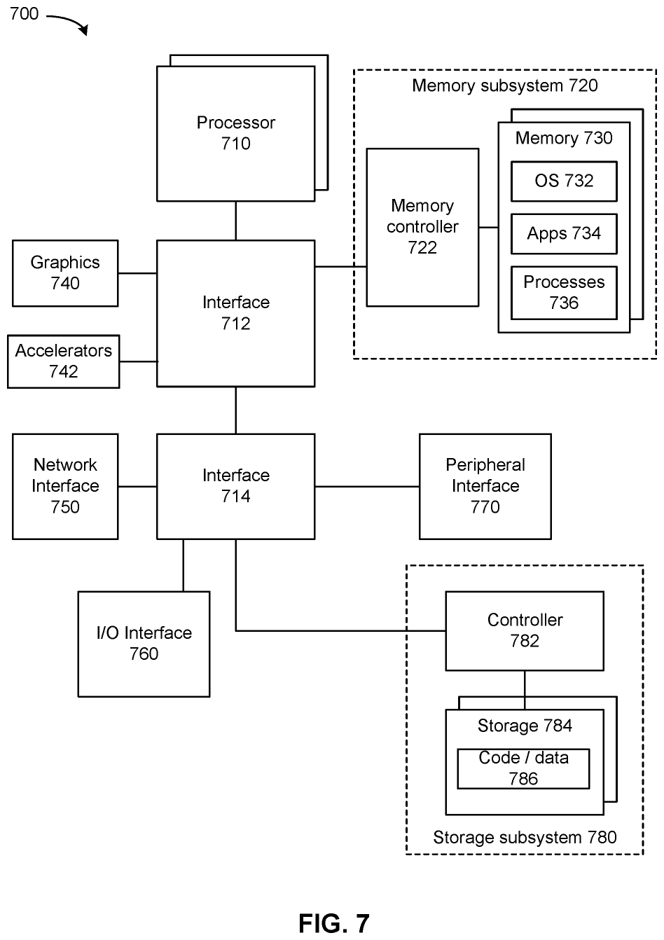

FIG. 7 depicts a system. In some examples, operation of programmable pipelines of network interface 750 can continue during updates to software executing on a processor that executes a control plane for the programmable pipelines, or other unavailability of the processor. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

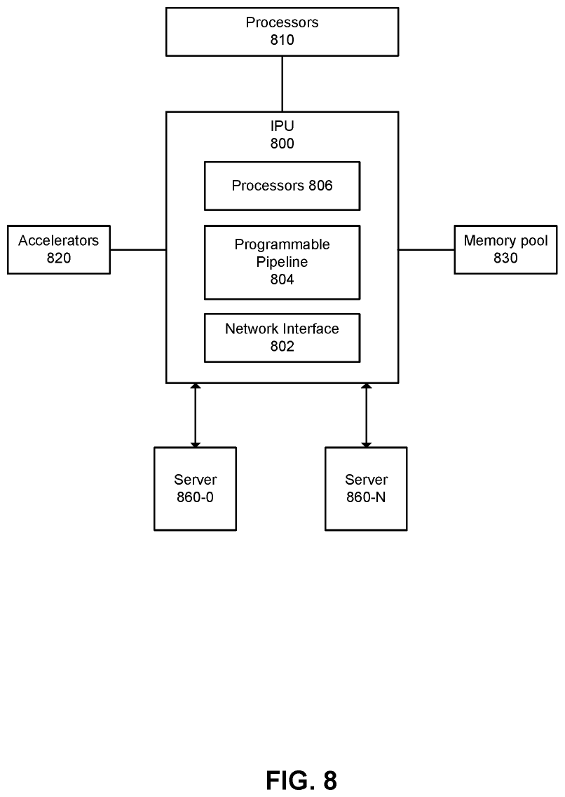

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, network interface 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 8.

In some examples, configuration of programmable pipelines of network interface 750 can be programmed using a processor of processors in network interface 750 and operation of the programmable pipelines can continue during updates to software executing on the processor, or other unavailability of the processor, as a second processor of the processors in network interface 750 provides connectivity to a host such as one or more servers and the second processor can configure operation of programmable pipelines.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802.

In some examples, configuration of programmable pipelines 804 can be programmed using a processor of processors 806 and operation of programmable pipelines 804 can continue during updates to software executing on the processor, or other unavailability of the processor, as a second processor of processors 806 provides connectivity to a host such as one or more of servers 860-0 to 860-N and the second processor can configure operation of programmable pipelines 804.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes an apparatus comprising: a packet processing device comprising: circuitry to perform packet processing operations according to a configuration and circuitry to execute control plane software to provide the configuration to the circuitry to perform packet processing operations according to the configuration, wherein the circuitry to perform packet processing operations according to the configuration is to continue operation independent of operation of the circuitry to execute control plane software.

Example 2 includes one or more examples, wherein the configuration comprises one or more match-action entries that specify packet processing and packet forwarding operations.

Example 3 includes one or more examples, wherein the packet processing device comprises circuitry to configure connectivity between a host and the circuitry to perform packet processing operations, wherein: based on unavailability of the circuitry to execute control plane software, the circuitry to configure connectivity between a host and the circuitry to perform packet processing operations is to apply a second configuration to maintain connectivity between the host and the circuitry to perform packet processing operations.

Example 4 includes one or more examples, wherein the second configuration comprises one or more of: access to data queues, interrupt settings, receive side scaling table allocation, or access to direct memory access (DMA) circuitry.

Example 5 includes one or more examples, wherein based on unavailability of based on unavailability of the circuitry to execute control plane software, the circuitry to configure connectivity between a host and the circuitry to perform packet processing operations is to configure packet processing operations of the circuitry to perform packet processing operations.

Example 6 includes one or more examples, wherein the unavailability of the circuitry to execute control plane software comprises change of one or more of: control plane operating system or control plane application.

Example 7 includes one or more examples, wherein the circuitry to perform packet processing operations comprises one or more of: a parser, exact match-action circuitry, wildcard match-action (WCM) circuitry, longest prefix match block (LPM) circuitry, a hash circuitry, a packet modifier, or traffic manager.

Example 8 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 9 includes one or more examples, and includes the host, wherein the host comprises one or more processors to execute a process to provide the configuration to the circuitry to execute control plane software.

Example 10 includes one or more examples, and includes a non-transitory computer-readable medium comprising instructions stored thereon, that if executed by one or more processors, cause the one or more processors to: configure a first processor to execute a control plane to configure a packet processing circuitry with a configuration, wherein the packet processing circuitry is to continue operation independent of operation of the first processor to execute a control plane and a packet processing device includes both the packet processing circuitry and the first processor to execute a control plane.

Example 11 includes one or more examples, wherein the configuration comprises one or more match-action entries and the one or more match-action entries specifies packet processing and packet forwarding operations.

Example 12 includes one or more examples, and includes instructions stored thereon, that if executed by one or more processors, cause the one or more processors to: configure a second processor to configure connectivity between a host and the packet processing circuitry according to a second configuration, wherein based on unavailability of the first processor, the packet processing circuitry is to maintain connectivity with the host based on the second configuration.

Example 13 includes one or more examples, wherein the second configuration comprises one or more of: access to data queues, interrupt settings, receive side scaling table allocation, or access to direct memory access (DMA) circuitry.

Example 14 includes one or more examples, and includes instructions stored thereon, that if executed by one or more processors, cause the one or more processors to: based on unavailability of the first processor, configure the second processor to configure packet processing operations of the packet processing circuitry.

Example 15 includes one or more examples, wherein the packet processing circuitry comprises one or more of: a parser, exact match-action circuitry, wildcard match-action (WCM) circuitry, longest prefix match block (LPM) circuitry, a hash circuitry, a packet modifier, or traffic manager.

Example 16 includes one or more examples, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

Example 17 includes one or more examples, and includes a method comprising: configuring a first processor of a packet processing device to configure a packet processing circuitry with a configuration, wherein the packet processing circuitry continues operation independent of operation of the first processor to execute a control plane and a packet processing device includes both the packet processing circuitry and the first processor to execute a control plane.

Example 18 includes one or more examples, wherein the configuration comprises one or more match-action entries.

Example 19 includes one or more examples, and includes configuring a second processor of the packet processing device to configure connectivity between a host and the packet processing device according to a second configuration, wherein based on unavailability of the first processor, the packet processing device is to apply the second configuration and maintain connectivity with the host.

Example 20 includes one or more examples, wherein the packet processing device includes one or more of: a parser, exact match-action circuitry, wildcard match-action (WCM) circuitry, longest prefix match block (LPM) circuitry, a hash circuitry, a packet modifier, or traffic manager.

What is claimed is:

1. An apparatus comprising:
a packet processing device comprising:
circuitry to perform packet processing operations according to a configuration and
circuitry to execute control plane software to provide the configuration to the circuitry to perform packet processing operations according to the configuration, wherein the circuitry to perform packet processing operations according to the configuration is to continue operation independent of operation of the circuitry to execute control plane software.

2. The apparatus of claim 1, wherein the configuration comprises one or more match-action entries that specify packet processing and packet forwarding operations.

3. The apparatus of claim 1, wherein the packet processing device comprises circuitry to configure connectivity between a host and the circuitry to perform packet processing operations, wherein:
based on unavailability of the circuitry to execute control plane software, the circuitry to configure connectivity between a host and the circuitry to perform packet processing operations is to apply a second configuration to maintain connectivity between the host and the circuitry to perform packet processing operations.

4. The apparatus of claim 3, wherein the second configuration comprises one or more of:
access to data queues, interrupt settings, receive side scaling table allocation, or access to direct memory access (DMA) circuitry.

5. The apparatus of claim 3, wherein based on unavailability of based on unavailability of the circuitry to execute control plane software, the circuitry to configure connectivity between a host and the circuitry to perform packet processing operations is to configure packet processing operations of the circuitry to perform packet processing operations.

6. The apparatus of claim 3, wherein the unavailability of the circuitry to execute control plane software comprises change of one or more of: control plane operating system or control plane application.

7. The apparatus of claim 1, wherein the circuitry to perform packet processing operations comprises one or more of: a parser, exact match-action circuitry, wildcard match-action (WCM) circuitry, longest prefix match block (LPM) circuitry, a hash circuitry, a packet modifier, or traffic manager.

8. The apparatus of claim 1, wherein the packet processing device comprises one or more of:
a network interface controller (NIC), a remote direct memory access (RDMA)-enabled NIC, SmartNIC, router, switch, forwarding element, infrastructure processing unit (IPU), or data processing unit (DPU).

9. The apparatus of claim 1, comprising the host, wherein the host comprises one or more processors to execute a process to provide the configuration to the circuitry to execute control plane software.

10. A non-transitory computer-readable medium comprising instructions stored thereon, that if executed by one or more processors, cause the one or more processors to:
configure a first processor to execute a control plane to configure a packet processing circuitry with a configuration, wherein the packet processing circuitry is to continue operation independent of operation of the first processor to execute a control plane and a packet processing device includes both the packet processing circuitry and the first processor to execute a control plane.

11. The non-transitory computer-readable medium of claim 10, wherein the configuration comprises one or more match-action entries and the one or more match-action entries specifies packet processing and packet forwarding operations.

12. The non-transitory computer-readable medium of claim 10, comprising instructions stored thereon, that if executed by one or more processors, cause the one or more processors to:
configure a second processor to configure connectivity between a host and the packet processing circuitry according to a second configuration, wherein based on unavailability of the first processor, the packet processing circuitry is to maintain connectivity with the host based on the second configuration.

13. The non-transitory computer-readable medium of claim 12, wherein the second configuration comprises one or more of: access to data queues, interrupt settings, receive side scaling table allocation, or access to direct memory access (DMA) circuitry.

14. The non-transitory computer-readable medium of claim 10, comprising instructions stored thereon, that if executed by one or more processors, cause the one or more processors to:
based on unavailability of the first processor, configure the second processor to configure packet processing operations of the packet processing circuitry.

15. The non-transitory computer-readable medium of claim 10, wherein the packet processing circuitry comprises one or more of: a parser, exact match-action circuitry, wildcard match-action (WCM) circuitry, longest prefix match block (LPM) circuitry, a hash circuitry, a packet modifier, or traffic manager.

16. The non-transitory computer-readable medium of claim 10, wherein the packet processing device comprises one or more of: a network interface controller (NIC), a remote direct memory access (RDMA)-enabled NIC, SmartNIC, router, switch, forwarding element, infrastructure processing unit (IPU), or data processing unit (DPU).

17. A method comprising:
configuring a first processor of a packet processing device to configure a packet processing circuitry with a configuration, wherein:
the packet processing circuitry continues operation independent of operation of the first processor to execute a control plane and
a packet processing device includes both the packet processing circuitry and the first processor to execute a control plane.

18. The method of claim 17, wherein the configuration comprises one or more match-action entries.

19. The method of claim 17, comprising:
configuring a second processor of the packet processing device to configure connectivity between a host and the packet processing device according to a second configuration, wherein based on unavailability of the first processor, the packet processing device is to apply the second configuration and maintain connectivity with the host.

20. The method of claim 17, wherein the packet processing device includes one or more of: a parser, exact match-action circuitry, wildcard match-action (WCM) circuitry, longest prefix match block (LPM) circuitry, a hash circuitry, a packet modifier, or traffic manager.
